(19) United States
(12) Patent Application Publication
(10) Pub. No.: US 2012/0136970 A1
(43) Pub. Date: May 31, 2012

(54) COMPUTER SYSTEM AND METHOD FOR MANAGING COMPUTER DEVICE

(75) Inventor: Chung-Nan Chen, Taipei City (TW)

(73) Assignee: INVENTEC CORPORATION, Taipei City (TW)

(21) Appl. No.: 13/159,802

(22) Filed: Jun. 14, 2011

(30) Foreign Application Priority Data
Nov. 29, 2010 (TW) 99141266

(51) Int. Cl. G06F 15/16

(52) U.S. Cl. 709/219

(57) ABSTRACT

A computer system and a method for managing computer devices, which are applicable to at least a computer device, are provided. The method includes the following steps: detecting a plurality of operation conditions of the computer device so as to obtain a system event log; triggering an alert event according to the system event log; turning the system event log into internet information according to the alert event and transmitting the internet information to a remote server through a internet, so as to use the remote server for interpreting the system event log.

### CROSS-REFERENCE TO RELATED APPLICATION

This application claims the priority benefit of Taiwan application serial no. 99141266, filed Nov. 29, 2010. The entirety of the above-mentioned patent application is hereby incorporated by reference herein and made a part of this specification.

### BACKGROUND OF THE INVENTION

1. Field of the Invention

This invention relates to the technology of a baseboard management controller (BMC), and particularly relates to a system and a method for managing cloud servers.

2. Description of Related Art

Intelligent platform management interface (IPMI) is a general interface standard developed to meet the requirements for intelligent hardware management. A baseboard management controller (BMC) is a core processing controller in an IPMI frame. The BMC utilizes sensors to monitor various working conditions of the firmware and hardware of a server, such as a microprocessor and system temperature, a fan speed, and so forth. Further, the BMC detects and records a plurality of abnormal conditions and performs a corresponding procedure, so as to timely eliminate the abnormal conditions. The BMC provides the functions of remote management, system status detection and recordation, data tracking, and system recovery, so as to satisfy the requirements for efficient management and low total costs.

However, during the research and development of BMC technology, it is noted that different BMCs may often execute different operations when receiving a plurality of abnormal messages from the sensors. For example, when receiving an abnormal message, some BMCs execute a proper alert procedure to notify the R & D personnel and display the abnormal message. However, some BMCs may directly shut down the server. As a consequence, the R & D personnel are required to go through several versions of adjustments, in order to identify the abnormal message and to execute a proper procedure correspondingly.

The management of several servers is depicted as FIG. 1. FIG. 1 illustrates a conventional method for managing a plurality of servers 120. The BMCs 130 of the servers 120 may generate different results when interpreting the abnormal messages, due to the difference in firmware versions, parameters, server model numbers, and functions. If the R & D personnel wish to unify the determination mechanism of every server 120, it is necessary to adjust each BMC 130 respectively, but it costs a lot of time and efforts.

### SUMMARY OF THE INVENTION

The invention provides a method for managing computer devices. The method utilizes a cloud mechanism and a remote server to interpret abnormal conditions of the computer devices that are under management and to give unified commands thereto. Therefore, the computer devices can be equipped with low-efficiency BMC (baseboard management controller) chips to reduce costs.

Furthermore, the invention provides a computer system, which also utilizes a cloud mechanism and a remote server to interpret abnormal conditions of the computer devices that are under management and to give unified commands thereto. The computer devices can be equipped with low-efficiency BMC chips to reduce costs.

The invention provides a method for managing computer devices, and the method is applicable to at least one computer device. The managing method includes the following steps. A plurality of operation conditions of the computer device are detected, so as to obtain a system event log. A cloud transmission event is triggered according to the system event log. Then, the system event log is turned into internet information according to the cloud transmission event, and the internet information is transmitted to a remote server via an internet, by which the remote server determines whether the system event log is abnormal and sends back a command or executes other operations accordingly.

In one embodiment of the invention, the cloud transmission event is an alert event, and the alert event is utilized to turn the system event log into the internet information.

In one embodiment of the invention, the method further comprises: the computer device receiving a corresponding command from the internet to execute a corresponding procedure, wherein the corresponding command is generated and sent back by the remote server according to the system event log.

In one embodiment of the invention, the remote server's interpretation of the system event log comprises the following steps: obtaining a BMC model number of the computer device according to internet information; recording a network address of the computer device; and analyzing the system event log of the internet information according to the BMC model number and generating a corresponding command.

From another aspect, the invention provides a computer system, which includes at least a computer device and a remote server. The computer device comprises a baseboard management controller for detecting a plurality of operation conditions of the computer device to obtain a system event log, utilizing the system event log to trigger a cloud transmission event, turning the system event log into internet information, and transmitting the internet information to the remote server on the internet. The remote server receives the internet information via the internet and interprets the system event log to determine if any abnormal condition occurs.

According to the embodiments of the invention, the determination function performed by the baseboard management controller of the computer device is transferred to the remote server, so that the remote server can unifiedly interpret abnormal conditions of the computer devices and give commands thereto through cloud mechanism and internet. According to the embodiments, R & D personnel can learn the occurrence of abnormal conditions from the system event log and enable every computer device to react to the same abnormal conditions in the same way. Since the baseboard management controller of the embodiments is not required to perform complicated determination function, the controller can be equipped with low-efficiency chips or module chips that are designed to have internet communication capability but provide no determination function, so as to reduce the expenses for computer devices.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a conventional method of managing a plurality of servers.

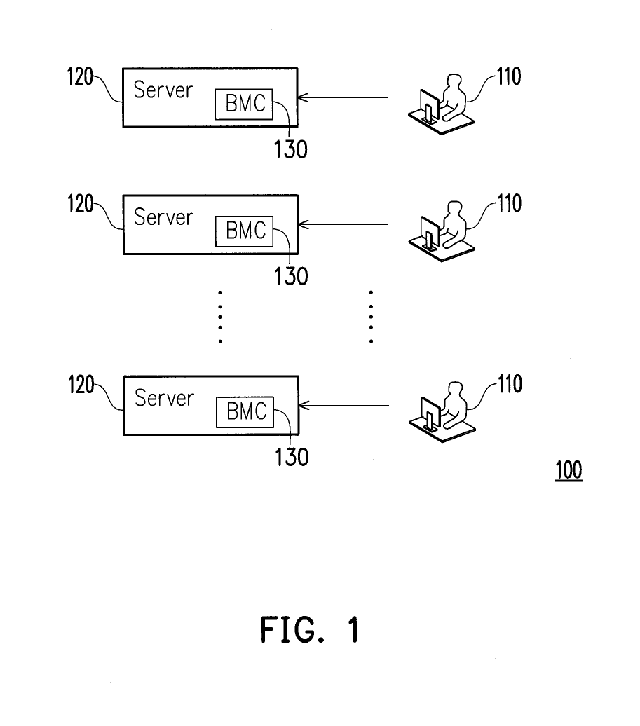

FIG. 2 is a block diagram, illustrating a frame of a general substrate management controller.

FIG. 3 illustrates a schematic view of a computer system according to an embodiment of the invention.

FIGS. 4A and 4B are block diagrams of a computer device and a remote server.

FIG. 5 is a flowchart illustrating a method for managing computer devices according to an embodiment of the invention.

### DESCRIPTION OF EMBODIMENTS

Descriptions of the invention are given with reference to the exemplary embodiments, which are illustrated by the accompanied drawings. Moreover, elements/components/notations with the same reference numerals represent the same or similar parts in the drawings and the embodiments.

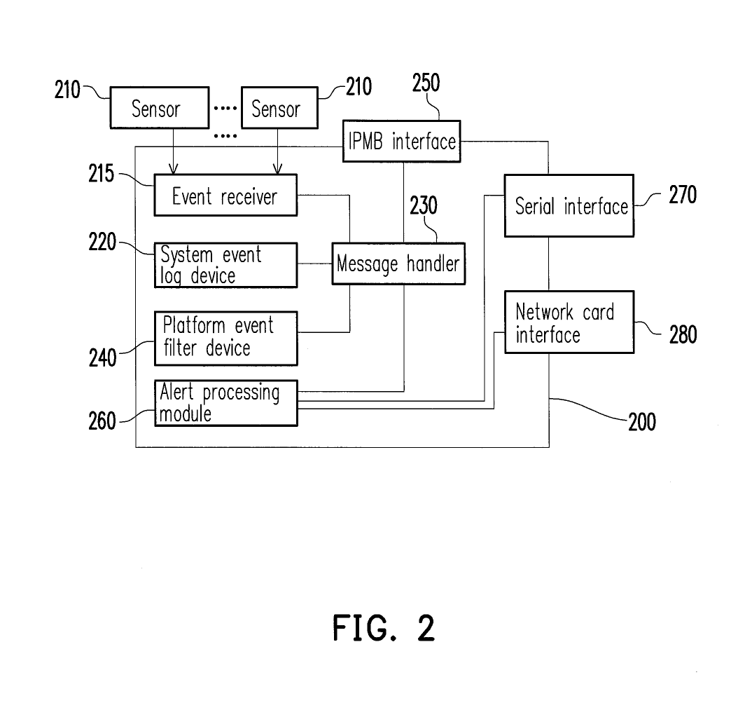

Referring to FIG. 2, FIG. 2 is a block diagram, illustrating a frame of a general baseboard management controller 200 (BMC). The baseboard management controller 200 is installed in a computer device and includes an event receiver 215, a system event log (SEL) device 220, a message handler 230, a platform event filter (PEF) device 240, an intelligent platform management bus (IPMB) interface 250, an alert processing module 260, a serial interface 270, a network card interface 280, and various types of sensors 210 disposed at different positions of the computer device.

A general baseboard management controller 200 utilizes the sensors 210 or other sensing devices connected to the IPMB interface 250 to detect the operation conditions of the computer device, e.g. a temperature of microprocessor, a fan speed, and so forth, and transmits the operation conditions to the event receiver 215 to be organized as a system event log (SEL). The system event log device 220 records and stores the system event logs.

The message handler 230 coordinates with the platform event filter device 240 to analyze the system event log and thereby determine whether the computer device functions properly. When the abnormal operation conditions are detected (such as overheat of microprocessor, malfunction of fan . . . ), the message handler 230 and the platform event filter device 240 execute a corresponding procedure to resume the operation of the computer device (such as adjusting the fan speed or performing the fan error-detection management), or the alert processing module 260 initiates an alert via the serial interface 270 or the network card interface (NIC) 280 to request maintenance.

According to the above, the general baseboard management controller 200 processes all the operations related to the computer device and performs management thereon. To enable the baseboard management controller 200 of each computer device to have unified determination mechanism of system abnormal conditions, the invention moves the determination function of the baseboard management controller to a remote server on the internet via cloud mechanism. Consequently, the baseboard management controller is not required to have high operation efficiency and the expenses for computer devices can be reduced.

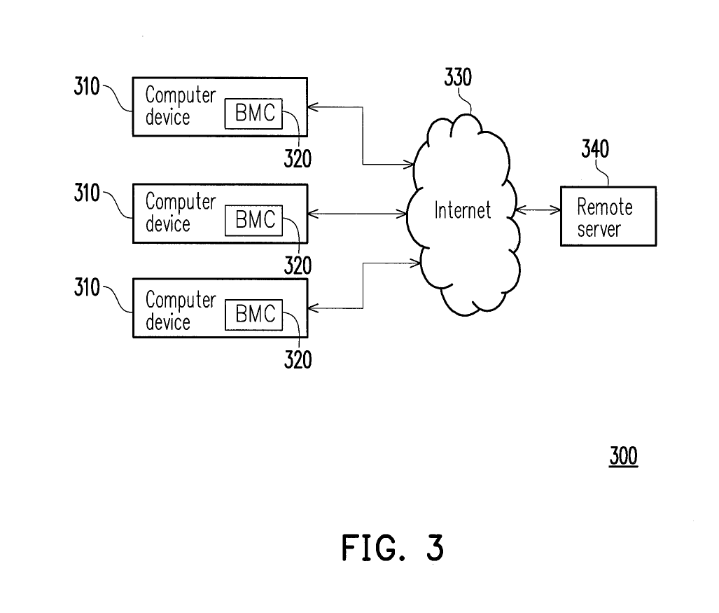

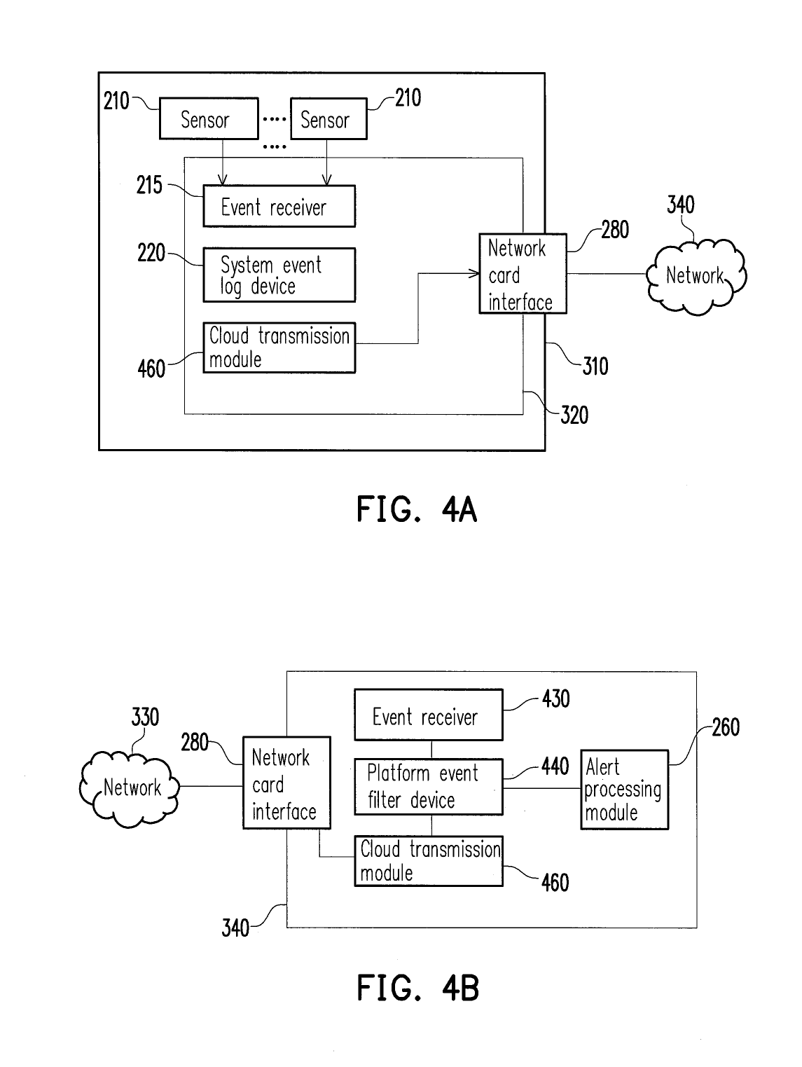

One embodiment is provided below to further describe the spirit of the invention. Referring to FIG. 3, FIG. 3 illustrates a schematic view of a computer system 300 according to one embodiment of the invention. The computer system 300 includes at least a computer device 310, an internet 330, and a remote server 340. Each computer device 310 further includes a baseboard management controller 320. The baseboard management controller 320 and the remote server 340 described in this embodiment are depicted in FIGS. 4A and 4B. FIGS. 4A and 4B are block diagrams, respectively illustrating the computer device 310 and the remote server 340.

In FIG. 4A, the computer device 310 is a server or other computer applications, but the invention is not limited thereto. The sensor 210, the event receiver 215, the system event log device 220, and the network card interface 280 disposed in the baseboard management controller 320, as described here, are the same as or similar to those in the embodiment of FIG. 2. Therefore, detailed descriptions are not repeated hereinafter. In FIG. 4B, the remote server 340 includes a message handler 430, a platform event filter device 440, a cloud transmission module 460, an alert processing module 260, and a network card interface 280.

According to this embodiment, in order to move the determination mechanism of the system event log to the remote server, the baseboard management controller 320 immediately transmits the system event log to the remote server 340 via the cloud transmission module 460 and the network card interface 280 after the system event log is generated by the event receiver 215. The remote server 340 receives the system event log through the internet 330 to interpret and determine if any abnormal operation condition occurs on the computer device 310, and then executes a corresponding procedure according to the abnormal condition or sends a corresponding command back to the computer device 310. It should be noted that, the cloud transmission event of the cloud transmission module 460 is executed by software, but it can also be performed by hardware through module, so as to reduce costs. However, the invention is not limited thereto.

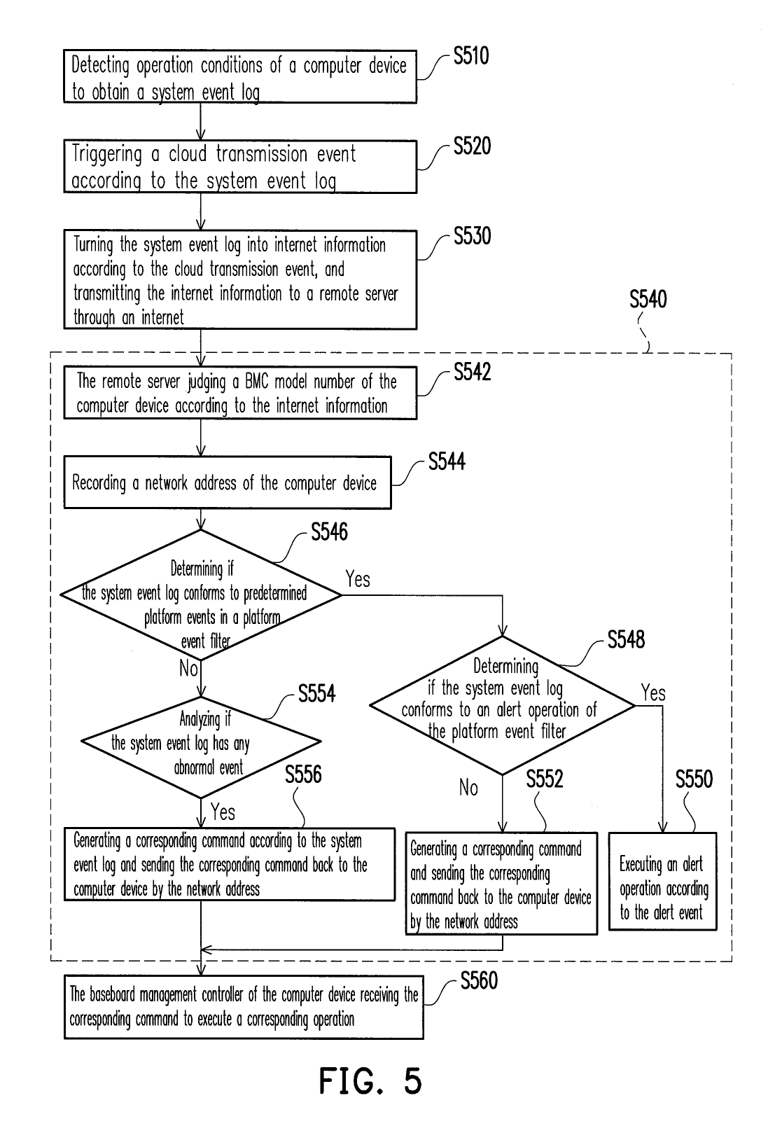

A method for managing a computer device 310, executed by the computer system 300, and an actuation step thereof are described in detail below. FIG. 5 is a flowchart illustrating a method for managing the computer device 310 according to one embodiment of the invention. Referring to FIG. 5 as well as FIGS. 4A and 4B, in Step S510, the baseboard management controller 320 utilizes various types of sensors 210 to obtain related reading (such as temperature of microprocessor, fan speed, and so forth), which is organized as the system event log by the event receiver 215 and then recorded by the system event log device 215. In Step S520, the system event log is used to trigger the cloud transmission event in the cloud transmission module 460.

In Step S530, the cloud transmission module 460 uses the cloud transmission event to turn the system event log into the internet information (for example, turning the system event log into package format) and transmits the internet information to the remote server 340 by means of the network card interface 280 and the internet 330. In other embodiments, the alert processing module 260, as shown in FIG. 2, also has the function of transmitting alert information through the network card interface 280. Therefore, the cloud transmission event of the cloud transmission module 460 can be replaced by the alert event of the alert processing module 260, and all the system event logs can be deemed as alert information and transmitted to the remote server 340, but the invention is not limited thereto.

Then, in Step S540, the remote server 340 receives the internet information through the internet 330 and determines if the system event log is abnormal, so as to perform determination and give commands unifiedly. According to this embodiment, Step S540, i.e. the step that the remote server interprets the system event log, includes Steps S542˜S556, which are described in detail below.

The remote server 340 can receive the internet information sent by the baseboard management controllers 320 of different model numbers. Therefore, in Step S542, the message handler 430 in the remote server 320 first utilizes related information in the internet information to judge the model number of the baseboard management controller 320 and performs classification accordingly. Then, in Step S544, the remote server 340 records a network address of the baseboard management controller 320 of the computer device 310 (such as IP address).

Thereafter, in Step S546, the remote server 340 obtains platform event filter (PEF) corresponding to the model number of the baseboard management controller 320 from the platform event filter device 440, and performs platform event filtering on the system event log to determine whether the information in the system event log conforms to predetermined platform events in the platform event filter.

If the information in the system event log conforms to one of the predetermined platform events, the remote server 320 proceeds to determine whether the platform event is an alert operation of the platform event filter (from Step S546 to Step S548). If the platform event is the alert operation of the platform event filter (from Step S548 to Step S550), the alert operation, such as requesting maintenance or adjusting system status indicators, is executed by using the alert event of the alert processing module 260. If the system event log is not the alert operation of the platform event filter (from Step S548 to Step S552), the platform event filter device 440 generates a corresponding command and sends the corresponding command back to the baseboard management controller 320 of the computer device 310 by the network address recorded in Step S544, the cloud transmission module 460, and the network card interface 280.

Further, if the system event log does not conform to the platform event filter, the message handler 430 analyzes the system event log to determine if the system event log is an abnormal event (from Step S546 to Step S554). If the system event log is an abnormal event, Step S556 is performed to generate the corresponding command according to the system event log and send the corresponding command back to the computer device 310 by the network address recorded in Step S544. In step 560, the baseboard management controller 320 in the computer device 310 then receives the corresponding command of Step S552 or Step S556 to execute an operation accordingly, such as start/shut down/reboot the computer device, adjust fan, control indicator, and so forth. On the contrary, if the system event log is not the abnormal event (in other words, the system event log is normal), the remote server 340 ignores this internet information (not shown).

In conclusion of the above, according to this embodiment, the system event log received by the remote server 340 allows R & D personnel to know the source of abnormal messages and enables each computer device to react to the same abnormal conditions in the same way. In other words, the computer system 300 in the embodiment of the invention can use IOL interface to achieve the purpose of I2C control. In addition, since the baseboard management controller 320 is not required to perform complicated determination function, it can be equipped with low-efficiency chips (such as AST1100 chips, produced by Aspeed Technology Inc.) to reduce the expenses for hardware.

To conclude, according to the embodiment of the invention, the determination function performed by the baseboard management controller of the computer device is transferred to the remote server, so as to allow the remote server to unifiedly interpret abnormal conditions of the computer devices under management and give commands thereto through cloud mechanism and internet. Accordingly, the system event log allows R & D personnel to know the source of abnormal messages and enables each computer device to react to the same abnormal conditions in the same way. Moreover, the baseboard management controller can be equipped with low-efficiency chips or module chips that are designed to have internet communication capability but provide no determination function, so as to reduce the expenses for computer devices.

Although the invention has been described with reference to the above embodiments, it is apparent to one of ordinary skill in the art that modifications to the described embodiments may be made without departing from the spirit of the invention. Accordingly, the scope of the invention is defined by the attached claims not by the above detailed descriptions.

What is claimed is:

1. A method for managing a computer device, applicable to at least one computer device, the method comprising:
detecting a plurality of operation conditions of the computer device to obtain a system event log;
triggering a cloud transmission event according to the system event log; and
turning the system event log into internet information according to the cloud transmission event and transmitting the internet information to a remote server via an internet, whereby the remote server determines whether the system event log is abnormal.

2. The method for managing the computer device as claimed in claim 1, wherein the cloud transmission event is an alert event, and the system event log is turned into the internet information according to the alert event.

3. The method for managing the computer device as claimed in claim 1, further comprising:
receiving a corresponding command from the internet to execute a corresponding procedure, wherein the corresponding command is generated and sent back by the remote server according to the system event log.

4. The method for managing the computer device as claimed in claim 1, wherein the remote server interpreting the system event log comprises:
obtaining a model number of a baseboard management controller (BMC) model of the computer device according to the internet information;
recording a network address of the computer device; and
analyzing the system event log of the internet information according to the model number of the BMC model and generating a corresponding command.

5. The method for managing the computer device as claimed in claim 4, wherein analyzing the system event log of the internet information to generate the corresponding command comprises:
determining whether the system event log conforms to a platform event filter (PEF) event;
when the system event log conforms to an alert operation of the PEF event, the remote server executing the alert operation by an alert event;
when the system event log conforms to the PEF event and generates the corresponding command, the remote server sending back the corresponding command by the network address;
if the system event log does not conform to the PEF event and no abnormal event occurs, the remote server generating the corresponding command according to the system event log and sending back the corresponding command by the network address; and
if the system event log does not conform to the PEF event and is an abnormal event, ignoring the internet information.

6. The method for managing the computer device as claimed in claim 1, further comprising:
the computer device recording the system event log.

7. A computer system, comprising:
at least a computer device, comprising:
a baseboard management controller (BMC), detecting a plurality of operation conditions of the computer device to obtain a system event log, triggering a cloud transmission event according to the system event log, and turning the system event log into an internet information; and
a remote server, receiving the internet information through an internet and interpreting the system event log to determine if the system event log is abnormal.

8. The computer system as claimed in claim 7, wherein the computer device receives a corresponding command from the internet to execute a corresponding procedure, and the corresponding command is generated and sent back by the remote server according to the system event log.

9. The computer system as claimed in claim 7, wherein the remote server obtains a BMC model number of the computer device according to the internet information and records a network address of the computer device, and analyzes the system event log of the internet information according to the BMC model number to generate a corresponding command.

10. The computer system as claimed in claim 7, wherein the baseboard management controller comprises:
a sensing module, detecting a plurality of operation conditions of the computer device;
an event receiver, coupled to the sensing module and determining whether the operation conditions are abnormal according to a result of the detection, so as to generate a system event log; and
an alert processing module, coupled to the event receiver and triggering the cloud transmission event according to the system event log, turning the system event log into the internet information, and transmitting the internet information to the internet via a network card interface.
